(19) United States
(12) Patent Application Publication
(10) Pub. No.: US 2019/0087249 A1
(43) Pub. Date: Mar. 21, 2019

(54) FAILURE PREDICTION SYSTEM, SERVER, AND RECORDING MEDIUM

(71) Applicant: Konica Minolta, Inc., Tokyo (JP)

(72) Inventor: Takanori Togawa, Tokyo (JP)

(73) Assignee: Konica Minolta, Inc., Tokyo (JP)

(21) Appl. No.: 16/135,708

(22) Filed: Sep. 19, 2018

(30) Foreign Application Priority Data
Sep. 20, 2017 (JP) 2017-180406

(51) Int. Cl. G06F 11/00; G06F 11/07; H04N 1/32; H04N 1/00; H04N 1/387

(52) U.S. Cl. CPC G06F 11/008; G06F 11/0733; G06F 11/079; H04N 1/00323; H04N 1/00718; H04N 1/3878; H04N 1/00244; H04N 1/32635

(57) ABSTRACT

A failure prediction system includes: one or more apparatuses; and a server that cooperates with the apparatuses to predict occurrence of a predetermined failure in a certain apparatus among the apparatuses, the server including a hardware processor that: collects data for predicting the occurrence of the failure, from the apparatuses; analyzes the collected data and obtains an important-feature amount for making a predetermined standard prediction model adapt to the certain apparatus; and transmits the obtained important-feature amount to the certain apparatus, and the certain apparatus including a hardware processor that: transmits the data of the certain apparatus to the server; receives the important-feature amount from the server; adjusts the standard prediction model with the received important-feature amount; and predicts the occurrence of the failure with application of the data of the certain apparatus to the adjusted prediction model.

### CROSS-REFERENCE TO RELATED APPLICATION

The entire disclosure of Japanese patent Application No. 2017-180406, filed on Sep. 20, 2017, is incorporated herein by reference in its entirety.

### BACKGROUND

### Technical Field

The present invention relates to a failure prediction system that predicts occurrence of a failure in an image forming apparatus or the like, a server, and a recording medium.

### Description of the Related Art

An apparatus, such as an image forming apparatus, has various failures in some cases. For example, a failure occurs that an image is formed with suddenly displacement from the center in the width direction of a sheet (hereinafter, referred to as unexpected displacement).

A mechanism of causing the unexpected displacement, is considered as follows: Because skew occurs in a sheet conveyed from a paper feed tray in some cases, typically, a registration roller is provided on the front side of a transferring position at which an image is transferred to a sheet. A sheet is temporarily abutted on the registration roller and then the orientation of the sheet is corrected in parallel to the registration roller. In this case, either corner of the front end of a skew conveyed sheet first abuts on the registration roller. After that, the sheet is generally rotated about the corner abutting on the registration roller, and then is corrected in parallel to the registration roller. Thus, if the skew of the sheet is large, the center in the width direction of the sheet is displaced by a large amount from an ideal conveying center in a case where the sheet abuts on the registration roller so as to be in parallel to the registration roller. As a result, an image is transferred such that the image is displaced in the width direction of the sheet.

FIG. 9 exemplifies a case where conveying is executed with no skew, a case where conveying is executed with slight skew, and a case where conveying is executed with large skew. In the case of no skew, the center in the width direction of the sheet agrees with the ideal conveying center. In the case of the conveying with the slight skew, slight displacement occurs between the center in the width direction of the sheet and the ideal conveying center, but the image is located in the sheet. In the case of the conveying with the large skew, large displacement occurs between the center in the width direction of the sheet and the ideal conveying center, and the image is displaced, partially lying off the sheet.

As a result, unexpected displacement occurs.

Causes of the unexpected displacement due to the mechanism are assumed, but are not verified, as follows:

paper powder adheres to, for example, a sensor that detects the position of a sheet or the paper powder adheres to a conveying roller so as to cause a slip

a damaged portion, such as buckling given to the front end of a sheet in supplying the sheet to a sheet feed tray, sticks to something and the sheet skews

a sheet is fed having slight skew due to the influence of a blow from a fan to the sheet in order to prevent double feeding in picking up the sheet from the sheet feed tray, furthermore, the amount of skew increases during conveying.

Note that JP 5987458 B2 discloses a technique of inhibiting skew and JP 2012-206794 A discloses a technique of reducing displacement in the width direction of a sheet caused by abutting to a registration roller. In addition, JP 2015-195475 A discloses a technique of taking countermeasures against paper powder, with static electricity.

Application of the techniques disclosed in JP 5987458 B2, JP 2012-206794 A, and JP 2015-195475 A, can reduce the influence of paper powder and make a reduction in skew, but unexpected displacement cannot be prevented completely. Because the unexpected displacement suddenly occurs per sheet, it is important that the occurrence of the unexpected displacement is first precisely predicted in order to take an effective measure. However, processing of predicting the unexpected displacement precisely has large throughput and requires large resources, such as a memory. Thus, when an apparatus singly executes the processing, the burden of the apparatus becomes large. Note that, for failures in various apparatuses in addition to the unexpected displacement, it is desirable that occurrence of each failure is predicted in advance without a large burden on each apparatus in order to take an appropriate measure.

### SUMMARY

One or more embodiments of the present invention provide a failure prediction system capable of precisely predicting occurrence of a failure such as unexpected displacement in an apparatus, reducing the burden of the apparatus, a server used in the system, and a recording medium storing a program therefor.

A failure prediction system according to one or more embodiments of the present invention comprises:

an apparatus to be determined; and

a server that cooperates with the apparatus to predict occurrence of a predetermined failure in the apparatus,

wherein the server includes

a hardware processor that:

collects data for the prediction of the occurrence of the failure, from a plurality of apparatuses;

analyzes the data collected by the hardware processor and derives an important-feature amount for making an adjustment such that a previously determined standard prediction model adapts to one apparatus; and

transmits the important-feature amount derived by the analyzer to the one apparatus, and

the apparatus includes

the hardware processor that:

transmits the data of the apparatus to the server;

receives the important-feature amount from the server;

adjusts the standard prediction model with the important-feature amount received by the hardware processor; and

predicts the occurrence of the failure with application of the data of the apparatus to the prediction model after the adjustment of the hardware processor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram of an exemplary configuration of a failure prediction system according to one or more embodiments of the present invention;

FIG. 2 is a diagram of another exemplary configuration of the failure prediction system according to one or more embodiments of the present invention;

FIG. 3 is a diagram of an exemplary sensor group disposed on a sheet conveying path of an image forming apparatus according to one or more embodiments of the present invention;

FIG. 4 is a chart of exemplary time differences of the front end of a sheet detected between front-end detecting sensors in a case where the sheet is conveyed correctly and in a case where the sheet slips, according to one or more embodiments of the present invention;

FIG. 5 is a timing chart of exemplary outputs of paired skew sensors in a case where the sheet having no skew is conveyed and in a case where the sheet having skew is conveyed, according to one or more embodiments of the present invention;

FIG. 6 is a block diagram of the schematic configuration of the image forming apparatus according to one or more embodiments of the present invention;

FIG. 7 is a block diagram of the schematic configuration of a server according to one or more embodiments of the present invention;

FIG. 8 is a sequence diagram of the operation according to prediction of occurrence of a failure to be performed by the failure prediction system according to one or more embodiments of the present invention; and

FIG. 9 is a diagram of a mechanism of causing unexpected displacement.

### DETAILED DESCRIPTION OF EMBODIMENTS

Hereinafter, one or more embodiments of the present invention will be described with reference to the drawings. However, the scope of the invention is not limited to the disclosed embodiments.

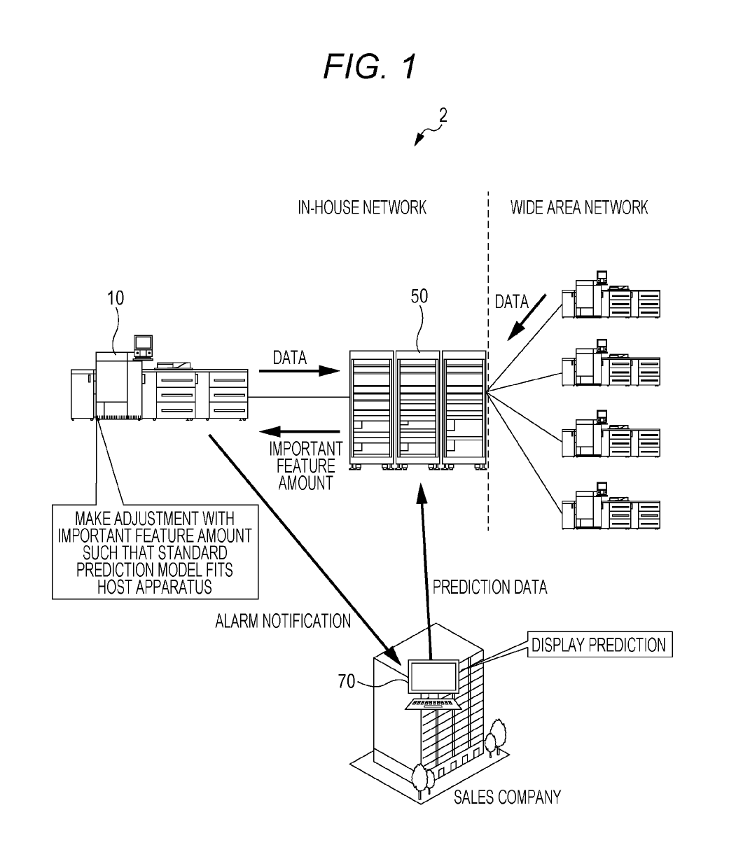

FIG. 1 is a diagram of an exemplary configuration of a failure prediction system 2 according to one or more embodiments of the present invention. The failure prediction system 2 includes an image forming apparatus 10 that is an apparatus to be determined, and a server 50. The image forming apparatus 10 and the server 50 are connected to an in-house network. Hereinafter, the image forming apparatus 10 will be also referred to as an MFP.

The server 50 is further connected to an external wide area network. The wide area network is connected with worldwide image forming apparatuses of the same model as and different models from the image forming apparatus 10 in large numbers. FIG. 1 illustrates only one image forming apparatus 10 on the in-house network side, but a plurality of image forming apparatuses 10 may be provided (typically, plural number). The in-house network is connected with, for example, a computer apparatus 70 in a sales company for the image forming apparatus 10.

In the failure prediction system 2, the image forming apparatus 10 and the server 50 cooperate to predict occurrence of a predetermined failure in the image forming apparatus 10. That is, because performance of all analysis for the prediction in the image forming apparatus 10 increases the burden of the image forming apparatus 10 (resources, such as a memory, or processing time), the burden is dispersed to the image forming apparatus 10 and the server 50.

Here, a standard prediction model for predicting the occurrence of the failure is distributed to each image forming apparatus 10. The server 50 derives an important-feature amount for making an adjustment such that the standard prediction model adapts to each individual image forming apparatus 10.

In the failure prediction system 2 illustrated in FIG. 1, in a case where the image forming apparatus 10 predicts the occurrence of the failure, for example, a notification with an alarm is issued to the computer apparatus 70 in the sales company.

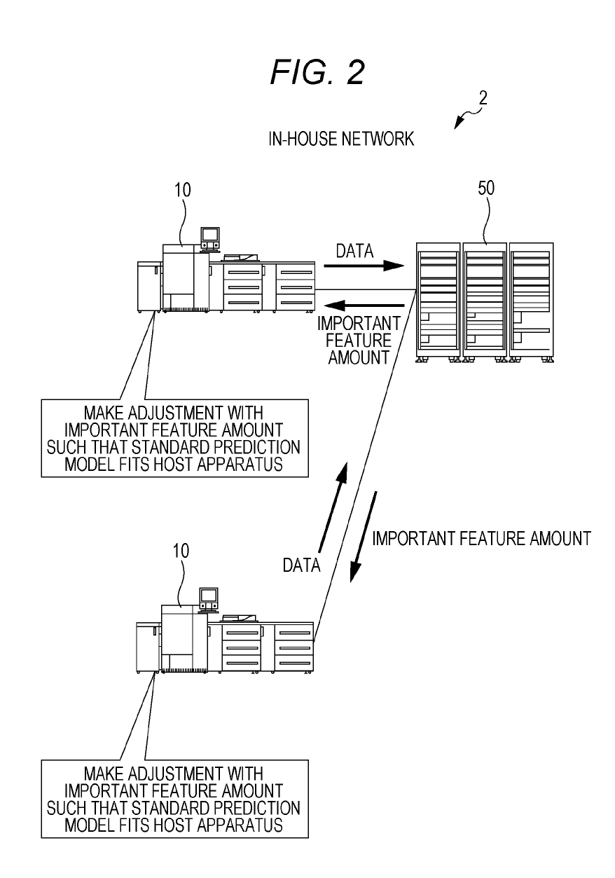

FIG. 2 illustrates another exemplary configuration of the failure prediction system 2. In FIG. 2, a server 50 is not connected to an external wide area network, but is connected to only an in-house network. Although the occurrence of the failure is predicted similarly to the system illustrated in FIG. 1, the server 50 collects data from only image forming apparatuses 10 connected to the in-house network.

A case where the failure to be predicted is unexpected displacement will be exemplarily described. An image forming apparatus 10 includes a sensor that detects the skew of a sheet or slipping of a conveying roller due to paper powder, regarded as a factor of the unexpected displacement.

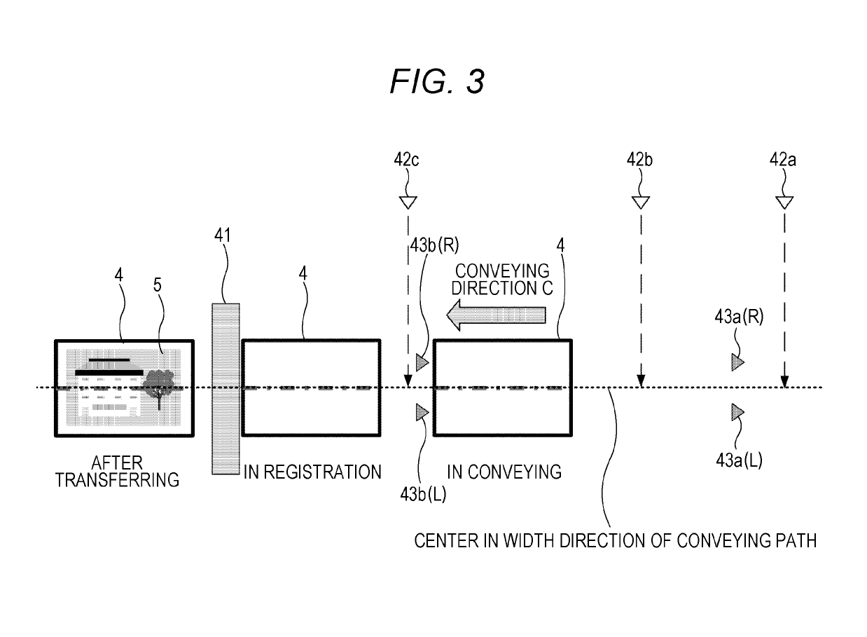

FIG. 3 illustrates an exemplary sensor group disposed on a sheet conveying path of the image forming apparatus 10. A front end detecting sensor 42 and paired skew sensors 43(R, L) are provided at proper positions of the conveying path between a paper feed tray and a registration roller 41. The front end detecting sensor 42 detects the front end of a sheet that is disposed and conveyed at the center in the width direction of the conveying path. The paired skew sensors 43(R, L) are disposed, at a predetermined distance, left and right symmetrically with respect to the center in the width direction of the conveying path. For example, the sensors each include an optical sensor having a light emitter and a light receiver that are disposed above and below across the conveying path, the light emitter and the light receiver being opposed to each other.

In the example of FIG. 3, as the front end detecting sensor 42, three number of front end detecting sensors 42a, 42b, and 42c are provided in upstream order. As the paired skew sensors 43, paired skew sensors 43a(R, L) are provided on the upstream side and paired skew sensors 43b(R, L) are provided on the downstream side.

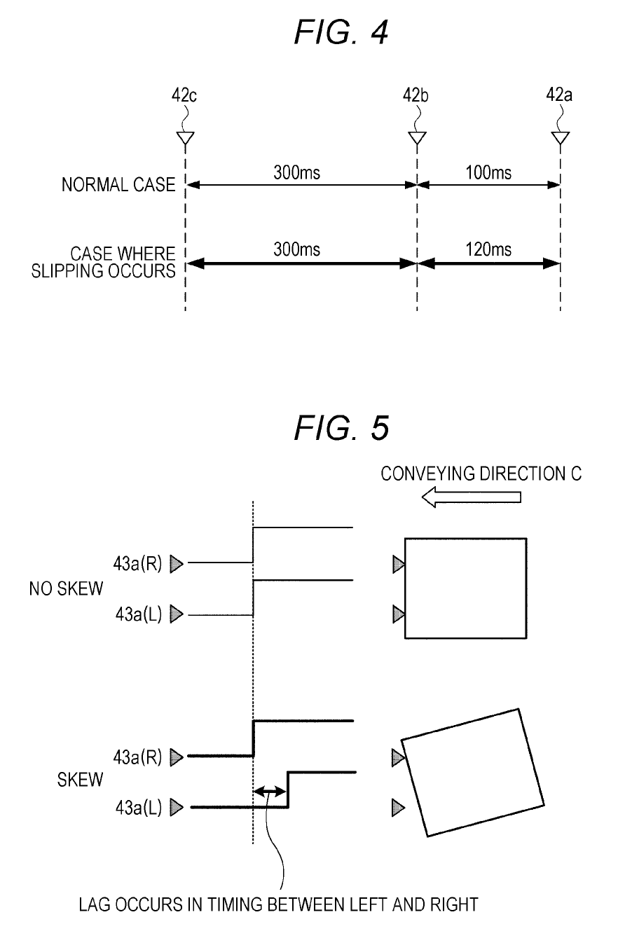

FIG. 4 illustrates exemplary time differences of the front end of a sheet 4 detected between the front end detecting sensors 42a to 42c in a case where the sheet 4 is conveyed correctly and in a case where the sheet 4 slips. For the correctly conveying, the time difference from the detection of the upstream front end detecting sensor 42a to the detection of the downstream front end detecting sensor 42b in terms of the front end of the sheet 4, is 100 ms. The time difference from the detection of the front end detecting sensor 42b to the detection of the downstream end face detecting sensor 42c in terms of the front end of the sheet 4, is 300 ms.

Meanwhile, each time difference for the slipping is longer than each time difference for the correctly conveying. In the example of FIG. 4, the time difference from the detection of the front end detecting sensor 42a to the detection of the front end detecting sensor 42b in terms of the front end of the sheet 4, is 120 ms and thus is 20 ms longer than that for the correctly conveying. Thus, it can be seen that the slip occurs on the conveying path between the front end detecting sensor 42a and the front end detecting sensor 42b.

FIG. 5 illustrates exemplary outputs of the paired skew sensors 43a(R, L) in a case where the sheet 4 having no skew is conveyed and in a case where the sheet 4 having skew is conveyed. Output values of the sensors during detection of the sheet, are High. For no skew, the left and right paired skew sensors 43a(R, L) detect the front end of the sheet, simultaneously. Meanwhile, for the sheet having the skew, a lag (time difference) occurs between the timing the right skew sensor 43a(R) detects the front end of the sheet and the timing the left skew sensor 43a(L) detects the front end of the sheet. The example of the sheet having the skew illustrated in FIG. 5, illustrates signals in a case where the sheet has the screw such that the left corner of the front end of the sheet is located on the upstream side of the right corner of the front end of the sheet.

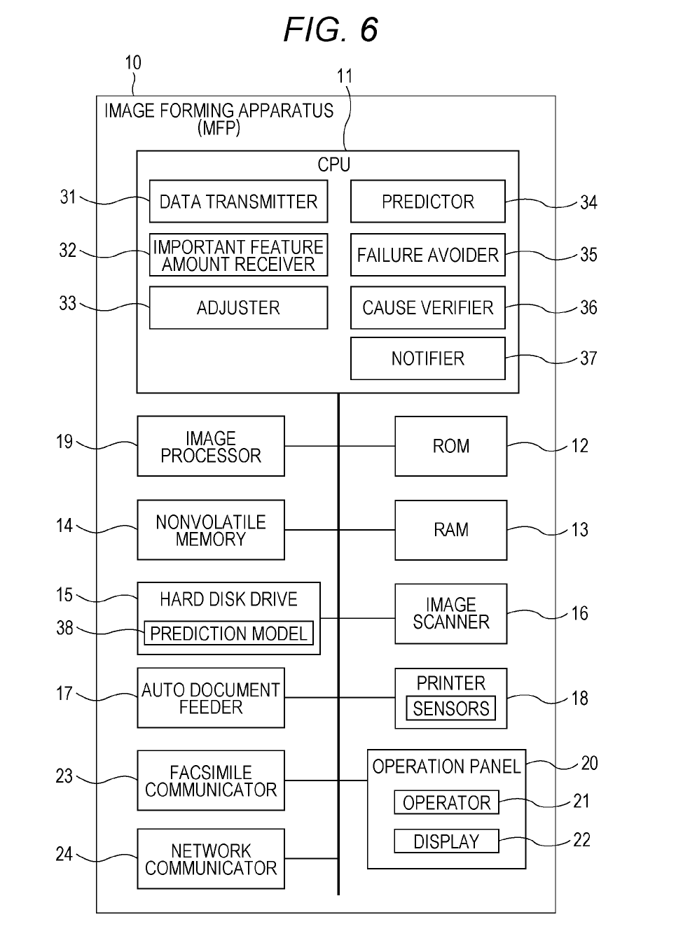

FIG. 6 is a block diagram of the schematic configuration of the image forming apparatus 10. The image forming apparatus 10 includes a central processing unit (CPU) 11 that controls the operation of the image forming apparatus 10 in a unificatory manner. The CPU 11 is connected with, for example, a read only memory (ROM) 12, a random access memory (RAM) 13, a nonvolatile memory 14, a hard disk drive 15, an image scanner 16, an auto document feeder (ADF) 17, a printer 18, an image processor 19, an operation panel 20, a facsimile communicator 23, and a network communicator 24, through a bus. The operation panel 20 includes an operator 21 and a display 22.

On the basis of an OS program, the CPU 11 executes middleware or an application program thereon. The ROM 12 and the hard disk drive 15 each store various programs, and the CPU 11 executes various types of processing in accordance with the programs, to achieve each function in the image forming apparatus 10.

For example, the RAM 13 is used for a work memory that temporarily stores various types of data when the CPU 11 executes processing on the basis of a program, or an image memory that stores image data. The RAM 13 also stores a program read by the hard disk drive 15.

The nonvolatile memory 14 including a memory (flash memory) in which the stored content is not destroyed even when power is turned off, is used for storing various types of setting information.

The hard disk drive 15 including a large-capacity nonvolatile storage, stores various programs or various types of data, in addition to a job, data of the job, and image data. The hard disk drive 15 also stores the standard prediction model 38.

The image scanner 16 functions to optically scan an original to acquire image data. For example, the image scanner 16 includes: a light source that irradiates an original with light; a line image sensor that scans one line in the width direction of the original, receiving the reflected light thereof; a translation unit that sequentially moves a scanning position for one line in the longitudinal direction of the original; an optical path in which, for example, a lens and a mirror that guide the reflected light from the original to the line image sensor, to form an image; and a converter that converts an analog image signal output from the line image sensor into digital image data.

The auto document feeder 17 functions to sequentially feed and convey originals set on an original tray, one sheet by one sheet from uppermost, to eject the originals to a predetermined copy receiving position through the scanning position of the image scanner 16. The image scanner 16 has a function of scanning an original mounted on a platen glass and a function of sequentially scanning originals conveyed by the auto document feeder 17.

The printer 18 functions to form an image corresponding to image data, onto recording paper. Here, the printer 18 is a so-called laser printer that includes: a conveying device for recording paper; a photoconductor drum; an electrifying device; a laser unit; a developing device; a transferring and isolating device; a cleaning device; and a fusing device, and executes image formation in electrophotographic process. The image formation may be executed in a different scheme. The printer 18 includes various sensors, such as the front end detecting sensor 42 and the paired skew sensors 43.

Note that the printer 18 desirably includes a line sensor that is disposed downstream of a transferring position and scans a sheet being conveyed and an image on the sheet. The scanned image of the line sensor enables whether the image on the sheet has the unexpected displacement, to be verified.

The image processor 19 executes, for example, rasterization processing of converting print data into image data and compression and decompression processing of image data, in addition to processing such as scaling and rotation of an image.

The operation panel 20 includes the operator 21 and the display 22. The display 22 functions to display various operation screens, and includes a liquid crystal display. The operator 21 includes various hard keys, such as a start button and a numeric keypad, and a touch screen provided on a display screen of the display 22, for receiving various operations from a user.

The facsimile communicator 23 functions to transmit image data to or receive image data from an apparatus having a facsimile function, through a telephone line.

The network communicator 24 functions to communicate with a PC 5 or various external apparatuses through a network.

In addition, the image forming apparatus 10 includes a sensor that detects the operation status of each part in the apparatus, sensors that detect temperature and humidity inside and outside the apparatus, and a function of acquiring information regarding date and time.

Execution of a program allows the CPU 11 to function as a data transmitter 31, an important-feature amount receiver 32, an adjuster 33, a predictor 34, a failure avoider 35, a cause verifier 36, and a notifier 37.

The data transmitter 31 functions to collect various types of data, such as measured values of sensors including the front end detecting sensor 42 and the paired skew sensors 43 in the host apparatus, temperature and humidity inside and outside the apparatus, the operation state of the apparatus, and an installed location, and repeatedly transmit the various types of data to the server 50 through the network communicator 24. For example, the data for the last one day is transmitted once a day.

The important-feature amount receiver 32 functions to receive the important-feature amount from the server 50 through the network communicator 24 and store the important-feature amount into the hard disk drive 15 or the nonvolatile memory 14.

The adjuster 33 functions to make an adjustment with the important-feature amount received from the server 50 such that the prediction model 38 fits the host apparatus.

The predictor 34 substitutes, for example, the measured values measured by the front end detecting sensor 42 and the paired skew sensors 43 of the host apparatus, into the prediction model after the adjustment with the important-feature amount, to execute computation. Then, the predictor 34 predicts whether the failure of the unexpected displacement is to occur. For example, the prediction is executed for each sheet in image formation operation.

In a case where a predicted result of the predictor 34 indicates that the unexpected displacement is to occur, the failure avoider 35 takes a measure for preventing the unexpected displacement from occurring. For example, the failure avoider 35 executes automatic correction of shifting the transferring position of an image in the width direction of a sheet such that the transferring position corresponds to the displacement of the sheet.

The cause verifier 36 verifies the cause of the occurrence of the unexpected displacement. For example, the cause verifier 36 verifies whether the cause is skew generated in picking up the sheet from the paper feed tray, skew due to the damage of the front end of the sheet caused in setting the sheet, skew caused during conveying, or slipping of a conveying roller due to paper powder. The cause verifier 36 executes the verification, on the basis of the important-feature amount and the measured values of the front end detecting sensor 42 and the paired skew sensors 43.

In a case where it is predicted that the unexpected displacement is to occur, the notifier 37 issues a notification with an alarm to the user of the image forming apparatus 10 or to the computer apparatus 70 in the sales company.

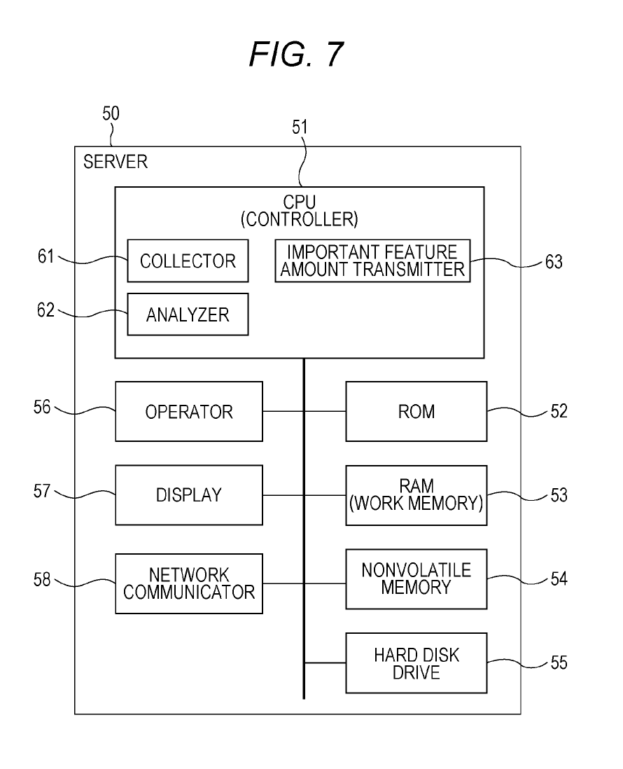

FIG. 7 illustrates the schematic configuration of the server 50. The server 50 includes a CPU 51 as a controller that controls the operation of the server 50 in a unificatory manner. The CPU 51 is connected with, for example, a ROM 52, a RAM 53, a nonvolatile memory 54, a hard disk drive 55, an operator 56, a display 57, and a network communicator 58, through a bus.

On the basis of an OS program, the CPU 51 executes middleware or various programs such as an application program thereon. The ROM 52 and the hard disk drive 55 each store various programs, and the CPU 51 executes various types of processing in accordance with the programs, to achieve each function in the print server 50.

For example, the RAM 53 is used for a work memory that temporarily stores various types of data when the CPU 51 executes processing on the basis of a program. The RAM 53 also stores a program read by the hard disk drive 55.

The nonvolatile memory 54 including a memory (flash memory) in which the stored content is not destroyed even when power is turned off, is used for storing various types of setting information.

The hard disk drive 55 including a large-capacity nonvolatile storage, stores various programs or various types of data. The hard disk drive 55 stores, for example, data collected from each image forming apparatus 10.

The display 57 functions to display, for example, various operation screens or setting screens. For example, the display 57 includes a liquid crystal display. The operator 56 functions to receive various operations. The network communicator 58 functions to communicate with an image forming apparatus 10, the computer apparatus 70 in the sales company, or other various external apparatuses through a network.

Execution of a program allows the CPU 51 to function as a collector 61, an analyzer 62, and an important-feature amount transmitter 63.

The collector 61 collects data for predicting the occurrence of the failure (here, the unexpected displacement) from a plurality of image forming apparatuses 10. The collected data is sequentially accumulated into the hard disk drive 55.

The analyzer 62 analyzes the data collected by the collector 61 and accumulated in the hard disk drive 55, to derive the important-feature amount for making an adjustment such that the standard prediction model 38 adapts to a target image forming apparatus 10. Here, the important-feature amount is derived for each image forming apparatus 10 connected to the in-house network.

The important-feature amount transmitter 63 transmits the important-feature amount derived by the analyzer 62, to the corresponding image forming apparatus 10. The operation in which the server 50 derives and transmits the important-feature amount to an image forming apparatus 10, may be executed once a week or once a month. The cycle of the transmission may be set optionally in response to the state of the system or the state of the image forming apparatus 10.

Next, the operation of the failure prediction system 2 will be described.

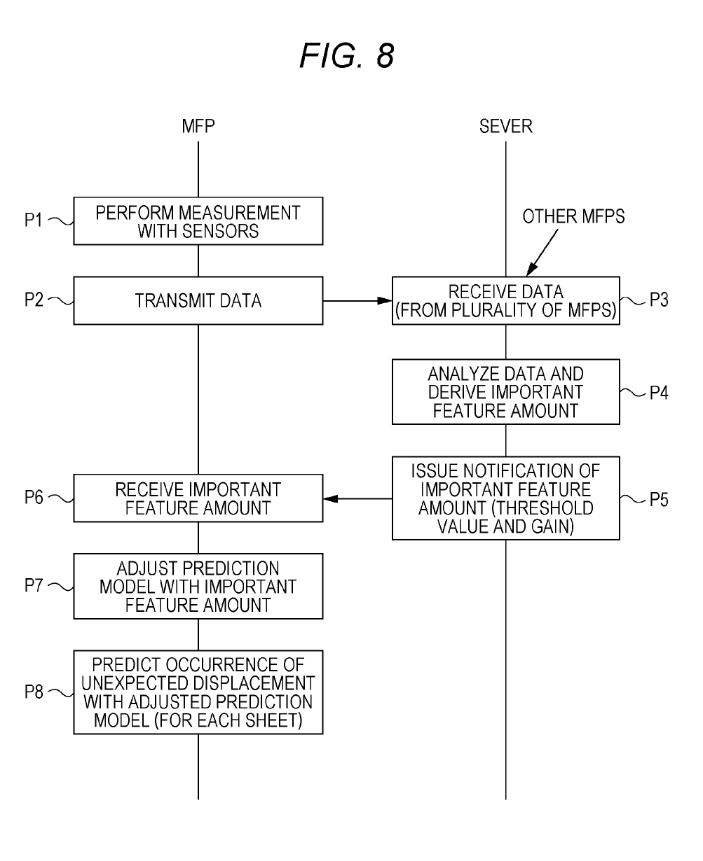

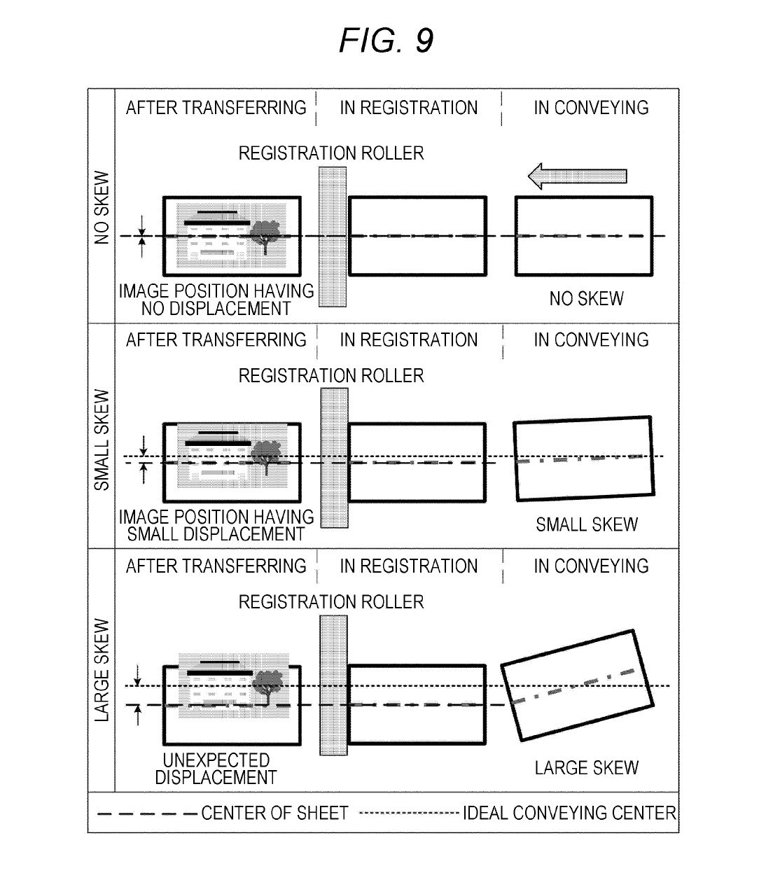

FIG. 8 is a sequence diagram of the operation according to the prediction of the occurrence of the failure to be executed by the failure prediction system 2. As data related to the occurrence of the failure (unexpected displacement), each image forming apparatus 10 successively transmits, for example, the measured values of the various sensors, the installed environment, and variation information regarding mechanical devices to the server 50 (P1).

The server 50 collects the data not only from the image forming apparatuses 10 connected to the in-house network, but also from a large number of worldwide image forming apparatuses 10 connected through the wide area network (P2).

On the basis of the data collected from the large number of image forming apparatuses 10 and the data received from the target image forming apparatuses 10, the server 50 derives the important-feature amount for making an adjustment such that the standard prediction model 38 adapts to one target image forming apparatus 10 (P4), and transmits the important-feature amount to the target image forming apparatus 10 (P5).

The image forming apparatus 10 receives the important-feature amount from the server 50 (P6), and adjusts the standard prediction model 38 with the received important-feature amount, to fit the standard prediction model 38 to the host apparatus (P7). Then, the image forming apparatus 10 substitutes, for example, the measured value of each sensor into the prediction model after the adjustment and executes computation to predict the occurrence of the failure (P8).

Note that the server 50 collects the data from the large number of image forming apparatuses 10 connected to the in-house network and the wide area network, to recognize a tendency for the occurrence of the failure for each attribute, such as an installed region or elapsed time after the installation. Then, the server 50 comprehensively determines the data received from a target image forming apparatus 10 and the tendency for each attribute of the target image forming apparatus 10, to derive the important-feature amount to the target image forming apparatus 10. This arrangement can derive the important-feature amount more precise (prediction based on the tendencies is included) than the important-feature amount derived on the basis of only the data from the target image forming apparatuses 10.

Note that it is desirable that the data is collected from the worldwide image forming apparatuses 10 as in the configuration of FIG. 1. However, even for the collection of the data from the image forming apparatuses 10 connected to in-house network as in the configuration of FIG. 2, if a large number of image forming apparatuses 10 are connected to the in-house network, a tendency can be analyzed therefrom.

In a case where it is predicted that the unexpected displacement is to occur, the failure avoider 35 of the image forming apparatus 10 takes the measure for avoiding the unexpected displacement. For example, the failure avoider 35 shifts the transferring position of an image in the width direction of a sheet in response to the skew amount or the skew direction of the sheet. Furthermore, the notifier 37 issues a notification with an alarm for the unexpected displacement, to the user or the computer apparatus 70 in the sales company. Here, in a case where it is predicted that the unexpected displacement is to occur even after the failure avoider 35 automatically executes the avoidance measure in order to prevent the unexpected displacement, the notifier 37 notifies the user of the image forming apparatus 10 that the unexpected displacement is to occur, with an alarm, and instructs the user to execute, for example, cleaning. Even after that, in a case where it is predicted that the unexpected displacement is to occur or in a case where the unexpected displacement occurs in practice, a notification is issued to the computer apparatus 70 in the sales company. The occurrence of the unexpected displacement in practice is detected by the line sensor described above or is recognized by reception of an input operation for that effect from the user who has executed visual verification.

Note that, here, the example in which the prediction model 38 is adjusted with the important-feature amount and then the occurrence of the failure is predicted with the prediction model after the adjustment, has been given, but the adjustment and the prediction may be simultaneously executed. For example, as parameters to be given to the function of the prediction model, the measured value of each sensor, a threshold value to each sensor, and a gain to each sensor are set. Then, all the parameters may be input into the prediction model, simultaneously, to compute a predicted result.

Next, the important-feature amount in a case where the unexpected displacement is predicted, will be described. The standard prediction model 38 is created so that the occurrence of the unexpected displacement can be precisely predicted in a case where, for example, the following conditions are satisfied: the environment of the image forming apparatus 10 has previously determined ideal temperature and humidity; and each sensor and the mechanical devices (e.g., a DC motor and a clutch) have a previously determined ideal characteristic.

The practical apparatus has temperature and humidity varying in response to the ambient environment or the operation status of the apparatus. There is variation in the characteristic of, for example, each sensor or the motor. Thus, substitution of only the measured values of the sensors into the standard prediction model 38, does not enable precise prediction to be executed.

The important-feature amount is an adjusting value for adjusting the standard prediction model 38 in consideration of the ambient environment, the characteristic of each of the sensors and the mechanical devices, and the variation thereof, of each image forming apparatus 10. Here, the important-feature amount includes a threshold value and a gain. The threshold value is a value to be compared with the measured value of each sensor, and, for example, when the measured value exceeds the threshold value, it is determined that the unexpected displacement is to occur. The gain is sensitivity (weight or reliability) to the determination based on the threshold value.

The prediction model comprehensively predicts the occurrence of the unexpected displacement, on the basis of measured values in a large number of items. Thus, the important-feature amount (the threshold value and the gain) is derived to the measured value of each of the sensors, such as the important-feature amount to the paired skew sensors 43a or the important-feature amount to the paired skew sensors 43b.

<Threshold Value>

For example, the standard prediction model 38 is set to determine that the unexpected displacement is to occur when the measured value of a sensor A exceeds 100. It is assumed that a target image forming apparatus 10 is recognized having the average value of output values of the sensor A deviated from an ideal value by +20, on the basis of the data collected from the image forming apparatuses 10. In this case, 120 is set as the threshold value to the sensor A.

<Gain>

If the output value remains the same constantly in a case where the sensor A measures a specific state, it can be said that the reliability of the sensor A is high and the reliability of a determined result in the comparison between the output value of the sensor A and the threshold value, is high. In this case, the gain is raised (for example, 1), and the determined result in the comparison between the output value of the sensor A and the threshold value increases the ratio of contribution to the comprehensive determination of the unexpected displacement.

Meanwhile, if the output value does not remain the same constantly and there is variation (there is dispersion) in a case where the sensor A measures the specific state, the reliability of the sensor A and the reliability of the determined result in the comparison between the output value of the sensor A and the threshold value are low. In this case, the gain is reduced (for example, 0.7) and the determined result in the comparison between the output value of the sensor A and the threshold value reduces the ratio of contribution to the comprehensive determination of the unexpected displacement.

Furthermore, in a case where, from each measured value in the data collected during the last predetermined period, it is determined that the frequency of a large amount of skew increases the possibility of the occurrence of the unexpected displacement (in a case where the probability of the occurrence of the unexpected displacement is a predetermined value or more), raising the gain increases the sensitivity of the prediction model, so that detection precision improves. Meanwhile, in a case where, from each measured value in the data collected during the last predetermined period, it is determined that a small amount of skew continues and the possibility of the occurrence of the unexpected displacement is low (in a case where the probability of the occurrence of the unexpected displacement is less than the predetermined value), reducing the gain decreases the sensitivity in order to prevent false detection of the occurrence of the unexpected displacement. Then, the important-feature amount is derived. Here, the example in which the detection precision is adjusted with the gain, has been exemplified, but the detection precision may be adjusted in a manner of setting the threshold value.

Next, an exemplary procedure when the server 50 derives the important-feature amount, will be given.

(1) The data is acquired from each machine (image forming apparatus 10).

(a) The measured values (maximum, minimum, and average values) of all the sensors related to the unexpected displacement

(b) Ambient environmental value

(c) Information regarding a location having variation from the devices in the machine

(2) Variation in the measured value of each sensor is categorized into five stages on the basis of the information in (a) to (c).

1.

Large displacement to +

2. Small displacement to +

3. Substantially no displacement

4. Small displacement to −

5. Large displacement to −

In this case, on the basis of the tendency recognized on the basis of the data collected from the worldwide image forming apparatuses 10 (or the image forming apparatuses 10 in large numbers connected to the in-house network) and the data collected from one target image forming apparatus 10, the important-feature amount is determined for the measured value of a predetermined item in the target image forming apparatus 10. For example, the value of the sensor A tends to decease in an image forming apparatus 10 installed in a subtropical region. In a case where a target image forming apparatus 10 is located in the subtropical region, on the basis of only the data collected from the target image forming apparatus 10, the sensor A is modified to “2. small displacement to +” in consideration of the tendency, instead of being categorized into “1. large displacement to +”.

(3) On the basis of the categorization, the threshold value and the gain to the measured value of each sensor of the machine are determined. Note that the categorization according to the threshold value and the categorization according to the gain are desirably individually executed. The gain is categorized on the basis of the degree of variation (dispersion) in the output value or the level of possibility of the occurrence of the unexpected displacement based on the data in the last predetermined period.

Next, verification of the cause of the occurrence of the unexpected displacement will be described.

(A) In a case where the paired skew sensors 43 that detect the skew of a sheet that is being conveyed, detects the skew (a lag (time difference) occurs in timing the front end of the sheet is detected between the left and right sensors), a causal location is verified, for example, on the basis of where the paired skew sensors 43 that have detected the lag are located in the conveying path.

(A-1) A case where the lag has been detected by the paired skew sensors 43 near the paper feed tray

It is verified that the sheet is fed having slight skew due to the influence of a blow from the fan to the sheet in order to prevent the double feeding in picking up the sheet from the sheet feed tray, or it is verified that the skew occurs due to the stick of a damaged portion, such as buckling given to the front end of the sheet in supplying the sheet into the sheet feed tray.

(A-2) A case where the lag has been detected by the paired skew sensors 43 in the midstream of the conveying path

It is verified that a conveying roller has a problem, on the periphery of the location of the paired skew sensors 43 that have detected the lag. For example, it can be thought that the conveying roller has paper powder, a stain, abrasion, and damage (mechanical problem).

(B) A case where the time difference between detection of the front end of a sheet by one front end detecting sensor 42 and detection of the front end of the sheet by the next front end detecting sensor 42, is longer than usual

A conveying roller located between the front end detecting sensors 42, has a problem.

For example, it can be thought that the conveying roller has paper powder, a stain, abrasion, and damage (mechanical problem).

Note that, in a case where the cause of the occurrence of the unexpected displacement is verified, use of the important-feature amount (the threshold value and the gain) inhibits deviation or variation in the output value of each of the sensors, from influencing a determined result.

In this manner, in the failure prediction system 2, the server 50 derives the important-feature amount on the basis of the data collected from each image forming apparatus 10, and notifies the image forming apparatus 10 of the important-feature amount. The image forming apparatus 10 makes an adjustment with the important-feature amount notification of which is issued such that the standard prediction model 38 adapts to the characteristic or variation of each of the sensors and the mechanical devices in the host apparatus. The occurrence of the unexpected displacement is predicted with the prediction model after the adjustment. Thus, the detection precision of prediction can be retained high with reduction of the burden of processing and resources in the image forming apparatus 10, in comparison with a case where the image forming apparatus 10 executes all processing singly.

The unexpected displacement has been exemplarily described in the aforementioned embodiments, but the failure to be predicted for occurrence is not limited to this. The important-feature amount including the threshold value and the gain, has been exemplarily described. However, the important-feature amount is not limited to the threshold value and the gain as long as the important-feature amount is an adjusting value effective in fitting the standard prediction model to each apparatus. Any coefficient value included in the function of the prediction model, may be provided.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A failure prediction system comprising:
a plurality of apparatuses; and
a server that cooperates with the apparatuses to predict occurrence of a predetermined failure in a certain apparatus among the apparatuses, wherein
the server comprises:
a hardware processor that:
collects data for predicting the occurrence of the failure, from the apparatuses;
analyzes the collected data and obtains an important-feature amount for making a predetermined standard prediction model adapt to the certain apparatus; and
transmits the obtained important-feature amount to the certain apparatus, and
the certain apparatus comprises:
a hardware processor that:
transmits the data of the certain apparatus to the server;
receives the important-feature amount from the server;
adjusts the standard prediction model with the received important-feature amount; and
predicts the occurrence of the failure with application of the data of the certain apparatus to the adjusted prediction model.

2. The failure prediction system according to claim 1, wherein in a case where probability of the occurrence of the failure is a predetermined value or more in the certain apparatus, the hardware processor of the server sets the important-feature amount to increase detection precision of the adjusted prediction model, in comparison with a case where the probability is less than the predetermined value.

3. The failure prediction system according to claim 1, wherein the data applied to the adjusted prediction model includes a measured value of a sensor included in the certain apparatus, and
the important-feature amount includes a threshold value to be compared with the measured value, and weight to be given to a compared result between the threshold value and the measured value.

4. The failure prediction system according to claim 1, wherein in a case where the hardware processor of the certain apparatus predicts that the failure is to occur, the hardware processor of the certain apparatus further executes processing of avoiding the occurrence of the failure.

5. The failure prediction system according to claim 1, wherein the hardware processor of the certain apparatus further verifies a cause of the failure.

6. The failure prediction system according to claim 1, wherein the certain apparatus is an image forming apparatus that forms an image onto a sheet, and
the failure is displacement of the image due to a conveying defect of the sheet.

7. A server in a failure prediction system in which a plurality of apparatuses and the server cooperate to predict occurrence of a predetermined failure in a certain apparatus among the apparatuses, the server comprising
a hardware processor that:
collects data for predicting the occurrence of the failure in the certain apparatus, from the apparatuses;
analyzes the collected data and obtains an important-feature amount for making a predetermined standard prediction model adapt to the certain apparatus; and
transmits the obtained important-feature amount, to the certain apparatus that adjusts the standard prediction model with the important-feature amount and predicts the occurrence of the failure with application of the data of the certain apparatus to the adjusted prediction model.

8. The server according to claim 7, wherein in a case where probability of the occurrence of the failure is a predetermined value or more in the certain apparatus, the hardware processor of the server sets the important-feature amount to increase detection precision of the adjusted prediction model, in comparison with a case where the probability is less than the predetermined value.

9. The server according to claim 7, wherein the data applied to the adjusted prediction model includes a measured value of a sensor included in the certain apparatus, and
the important-feature amount includes a threshold value to be compared with the measured value, and weight to be given to a compared result between the threshold value and the measured value.

10. The server according to claim 7, wherein the certain apparatus is an image forming apparatus that forms an image onto a sheet, and
the failure is displacement of the image due to a conveying defect of the sheet.

11. A non-transitory computer readable recording medium storing a program causing a server in a failure prediction system in which a plurality of apparatuses and the server cooperate to predict occurrence of a predetermined failure in a certain apparatus among the apparatuses, to execute:
collecting data for predicting the occurrence of the failure in the certain apparatus, from the apparatuses;
analyzing the collected data to obtain an important-feature amount for making a predetermined standard prediction model adapt to the certain apparatus; and
transmitting the obtained important-feature amount to the certain apparatus that adjusts the standard prediction model with the important-feature amount and predicts the occurrence of the failure with application of the data of the certain apparatus to the adjusted prediction model.

12. The non-transitory computer readable recording medium according to claim 11, wherein the analyzing includes setting, in a case where probability of the occurrence of the failure is a predetermined value or more in the certain apparatus, the important-feature amount to increase detection precision of the adjusted prediction model, in comparison with a case where the probability is less than the predetermined value.

13. The non-transitory computer readable recording medium according to claim 11, wherein the data applied to the adjusted prediction model includes a measured value of a sensor included in the certain apparatus, and
the important-feature amount includes a threshold value to be compared with the measured value, and weight to be given to a compared result between the threshold value and the measured value.

14. The non-transitory computer readable recording medium according to claim 11, wherein the certain apparatus is an image forming apparatus that forms an image onto a sheet, and
the failure is displacement of the image due to a conveying defect of the sheet.
